(19) United States
(12) Patent Application Publication
(10) Pub. No.: US 2005/0115410 A1
(43) Pub. Date: Jun. 2, 2005

(54) Method and device for avoiding the deposition of soot on the insulating components of an electrostatic filter

(76) Inventors: Christian Charles Garabedian, Voujeaucourt (FR); Regis Vonarb, Vezelais (FR); Daniel Teboul, Ales (FR)

Correspondence Address: FULBRIGHT & JAWORSKI, LLP, 666 FIFTH AVE, NEW YORK, NY, 10103-3198, US

(21) Appl. No.: 10/502,375

(22) PCT Filed: Jan. 24, 2003
(86) PCT No.: PCT/FR03/00239

(30) Foreign Application Priority Data
Jan. 24, 2002 (FR) 02/00893

(51) Int. Cl. B03C 3/41

(52) U.S. Cl. 96/66; 96/15

(57) ABSTRACT

The invention relates to a method and device for avoiding the deposition of particles of soot (3) on the insulating components (2) in an electrostatic filter (1), which comprises the insulating components (2). The method comprises the method step of creating a repulsive electrostatic field (4) around said insulating components (2), by placing at least one repulsive electrode (8) in or on at least one of the insulating components (2) and applying an adequate voltage to the repulsive electrode (8). The voltage difference between the repulsive electrode (8) and the central electrode (6) and the voltage difference between the repulsive electrode (8) and the peripheral electrode (7) creates an electrical repulsive field (4), which repulses the particles of soot having an electrical charge. The formation of a conducting channel (5) on the surface of said insulating components (2) between the central electrode (6) and the peripheral electrode (7) can thus be avoided.

In an electrostatic filter having insulating parts, the invention relates to a method and a system for preventing the deposit of soot particles on the insulating parts.

In electrostatic filtration systems comprising a center electrode and a peripheral electrode, a film of soot is observed to form on the surface of the insulators which hold the central and peripheral electrodes. Under the effect of the high voltage applied between these electrodes a conductive channel forms in the soot deposited on the walls. The applied voltage collapses, and the electrostatic filtration effectiveness is diminished, and even lost.

The invention has the purpose of preventing the deposit of soot on the insulating parts of the electrostatic filtration system by an effective means of low power consumption.

### PRIOR ART

Various companies concerning themselves with problems of electrostatic filtration applied to the automobile have attempted to offer a solution to the stated problem. Among the different solutions already described, the following are mentioned:
The solution taught by U.S. Pat. No. 5,263,317. It consists in projecting a flow of air to release soot from the insulating parts.
The solution taught by U.S. Pat. No. 5,006,134. It consists in using resistances placed in contact with the insulating parts to burn off the soot.

The solutions proposed have the major disadvantages of being difficult to embody, not very effective and/or of great power consumption.

### Solution

### Process

The invention relates to a method, in an electrostatic filter having insulating parts, for preventing the deposit of soot particles on the insulating parts. The method of the invention includes the step of creating a repellent electrical field in the vicinity of the insulating parts. This prevents the formation of a conductive path on the surface of the insulating parts.

Preferably, according to the invention the electrostatic filter comprises at least one center electrode and one peripheral electrode held by the insulating parts. In the case of this variant embodiment, to create the repellent electrical field:
at least one repelling electrode is placed in or on at least one of the insulating parts,
an adequate voltage is applied to the repelling electrode.

The result of the combination of technical characteristics is that the potential difference between the repelling electrode and the center electrode, as well as the potential difference between the repelling electrode and the peripheral electrode creates an electrical field repelling the soot particles. This prevents the formation of a film of soot on the surface of the insulating parts. The formation of a conductive path on the surface of the insulating parts, in and/or on the film of soot, between the center electrode and the peripheral electrode.

Preferably, according to the invention the voltage applied to the repelling electrode is between −10 KV and −25 KV.

Preferably, according to the invention the potential difference between the repelling electrode and the center electrode is between −35 KV and 0 KV.

Preferably, according to the invention, the process is such that the potential difference between the repelling electrode and the peripheral electrode is between −10 KV and −25 KV.

### System

The invention likewise relates to a system for preventing, in an electrostatic filter comprising insulating parts, the deposit of soot particles on the insulating parts. The system comprises means for creating a repellent electrical field in the vicinity of the insulating parts. The formation of a conductive path on the surface of the insulating parts is thus prevented.

Preferably, according to the invention the electrostatic filter comprises at least one center electrode and one peripheral electrode held by the insulating parts. In the case of this variant embodiment, the repulsion means for the creation of a repellent electrical field near insulating parts include:
a repelling electrode situated in or on the insulating part,
a generator of adequate voltage connected to the repelling electrode.

The potential difference between the repelling electrode and the center electrode, as well as the potential difference between the repelling electrode and the peripheral electrode creates an electrical field repelling the particles of soot. The formation of a soot film is thus prevented and, correlatively, the formation of a conductive path on the surface of the insulating parts between the center electrode and the peripheral electrode.

Preferably, the repelling electrode is mounted on the center electrode and is of a bell-like shape covering the insulating parts.

Preferably, according to the invention the voltage supplied by the voltage generator and applied to the repelling electrode is between −10 KV and −25 KV.

Preferably, according to the invention the voltage supplied by the voltage generator is such that the potential difference between the repelling electrode and the center electrode is between −35 KV and 0 KV.

Preferably, according to the invention the voltage supplied by the voltage generator is such that the potential difference between the repelling electrode and the peripheral electrode is between −10 KV and −25 KV.

### DETAILED DESCRIPTION

Other features and advantages of the invention will appear in the reading of the description of variant embodiments of the invention given by way of suggestive and non-restrictive example, and from:

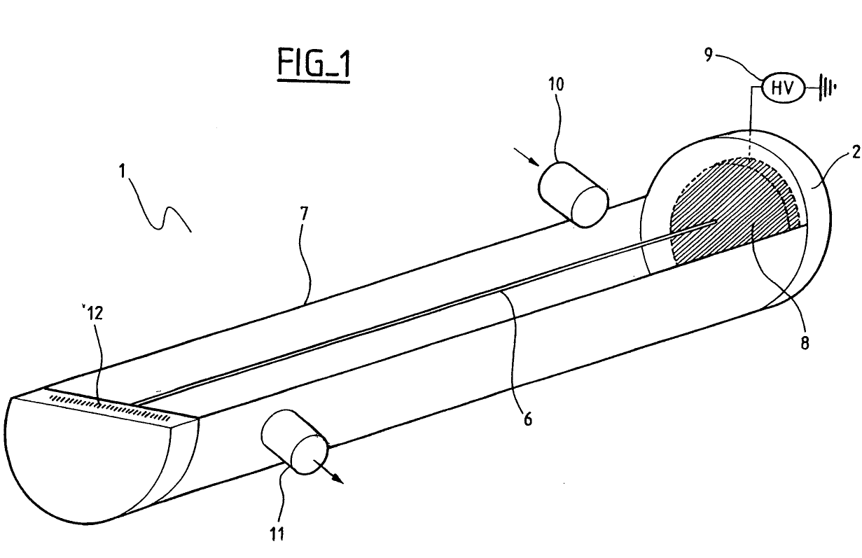

FIG. 1 which represents a schematic, partially cut-away view, of a variant embodiment of the invention,

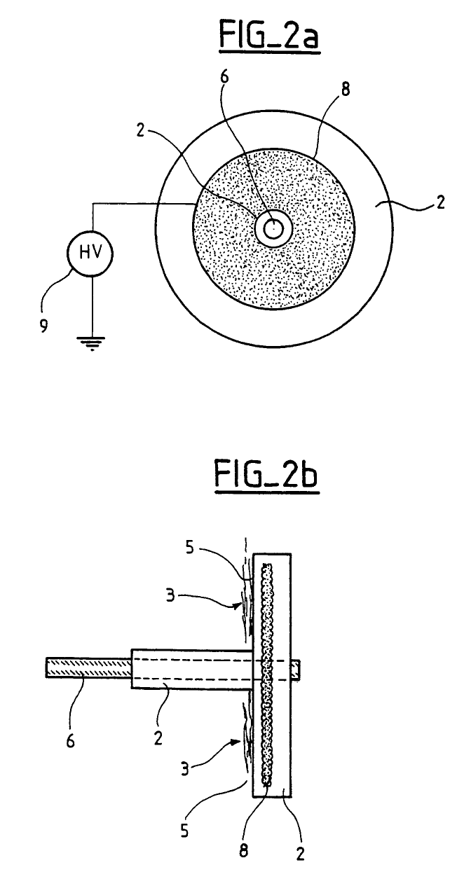

FIG. 2a and FIG. 2b, representing respectively a left-hand view and a view partially in section of the variant shown in FIG. 1.

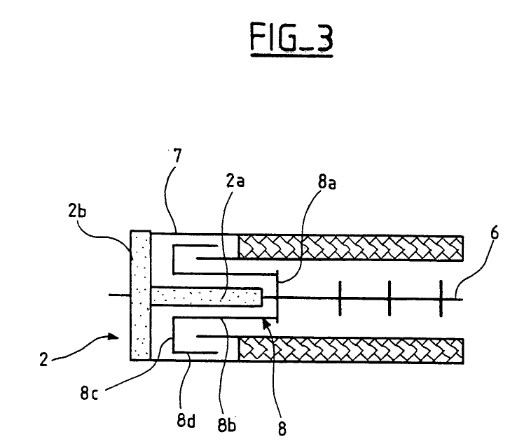

FIG. 3 representing a schematic view in section of another variant embodiment of the invention.

The electrostatic filter 1 has at least one center electrode 6 and a peripheral electrode 7 (forming the outer wall of the electrostatic filter 1). The center electrode 6 and the peripheral electrode 7 are held by insulating parts 2. The exhaust gases of the motor from which the soot is to be eliminated enter through inlet pipes 10 and leave through outlet pipes 11. The electrostatic filter 1 likewise contains repulsion means to create a repulsion electrical field 4 in the vicinity of the insulating parts 2. These repulsion means comprise a repelling electrode 8 and 12 situated in the insulating part, and a voltage generator 9 connected to the repelling electrodes 8 and 12. In a variant embodiment the metal repelling electrode 8 and 12 is covered with an insulating material, particularly an enamel coating.

The potential difference between the repelling electrode 8 and the central electrode 6, as well as the potential difference between the repelling electrode 8 and the peripheral electrode 7 creates a repulsion electrical field driving back the soot particles. Thus the deposit of soot particles 3 on the surface of the insulating parts 2 is prevented. This prevents the formation of a conductive pathway 5 on the surface of the insulating parts 2 in or on the soot particles 3 between the center electrode 6 and the peripheral electrode 7.

The voltages delivered by the voltage generator 9 and applied to the repelling electrode 8 are appropriate for this purpose. The repelling electrode 8 can be:
at the same potential as the center electrode 6,
at a potential different from that of the center electrode 6; in this case the potential of the repelling electrode 8 is of the same sign as the potential of the center electrode 6,
at a potential lower than the potential of the center electrode 6.

Preferably, the voltage supplied by the voltage generator 9 and applied to the repelling electrode 8 is between −10 KV and −25 KV.

Preferably, the voltage supplied by the voltage generator 9 is such that the potential difference between the repelling electrode 8 and the center electrode 6 is between −35 KV and 0 KV.

Preferably, the voltage supplied by the voltage generator 9 is such that the potential difference between the repelling electrode 8 and the peripheral electrode is between −10 KV and −25 KV.

A description will now be given of FIG. 3 representing a schematic view in section of another variant embodiment of the invention. Most of the elements described will be seen in this figure by referring to FIGS. 1, 2a and 2b. They bear the same reference numbers.

In the case of this other variant embodiment, the repelling electrode 8 is mounted on the center electrode 6, close to the cylindrical insulating portion 2 bearing the center electrode 6. The repelling electrode 8 is of a bell-like shape extending over the insulating parts 2. More precisely, the repelling electrode of bell-like shape is closed by a disk 8a affixed to the center electrode 6. The plane of disk 8a is perpendicular to the center electrode 6. The disk 8a is prolonged by a cylindrical tube 8b surrounding the insulating part 2a bearing the center electrode 6 and extending to the vicinity of the annular portion 2b of the insulating portion bearing the peripheral electrode 7. An annular disk 8c is affixed to the tube 8b, parallel to the annular portion 2b of the insulating part. A cylindrical skirt 8d is affixed to the annular disk 8c. The cylindrical skirt 8d is concentric with the peripheral electrode 7 and is situated near the latter. The elements 8a, 8b, 8c and 8d form the bell 8.

1-11. (canceled)

12. A method for preventing the deposit of soot particles on insulating parts of an electrostatic filter, comprising the step of generating an electrical repulsion filed in the vicinity of said insulting parts to prevent the formation of a conductive channel on the surface of said insulating parts.

13. The method of claim 12, wherein said electrostatic filter comprises at least one center electrode and at least one peripheral electrode held by said insulating parts; and wherein the step of generating said electrical repulsion field comprises the steps of:
placing at least one repelling electrode in or on at least one of said insulating parts; and
applying voltage to said repelling electrode, such that the potential difference between said repelling electrode and said center electrode and the potential difference between said repelling electrode and said peripheral electrode generates said electrical repulsion field for repelling electrically charged soot particles, thereby preventing the formation of said conductive channel on the surface of said insulating parts between said center electrode and said peripheral electrode.

14. The method of claim 13, wherein the step of applying voltage applies said voltage between −10 KV and −25 KV to said repelling electrode.

15. The method of claim 14, wherein the step of applying voltage applies said voltage to said repelling electrode such that the potential difference between said repelling electrode and said center electrode is between −35 KV and 0 KV.

16. The method of claim 14, wherein the step of applying voltage applies said voltage to said repelling electrode such that the potential difference between said repelling electrode and said peripheral electrode is between −10 KV and −25 KV.

17. A system for preventing the deposit of soot particles on insulating parts of an electrostatic filter, comprising repulsion means for generating a repulsion electrical field in the vicinity of the said insulating parts to prevent the formation of a conductive path on the surface of the said insulating parts.

18. The system of claim 17, wherein said electrostatic filter comprises at least one center electrode and at least one peripheral electrode held by the said insulating parts; and wherein said repulsion means further comprising:
a repelling electrode situated in or on the insulating part; and a
a voltage generator for generating and applying a voltage to said repelling electrode, such that the potential difference between said repelling electrode and said center electrode and the potential difference between said repelling electrode and said peripheral electrode generates said repulsion electrical field for repelling electrically charged soot particles, thereby preventing the formation of said conductive path on the surface of the said insulating parts between said central electrode and said peripheral electrode.

19. The system of claim 18, wherein said repelling electrode having the shape of a bell covering said insulating parts is mounted on the said center electrode.

20. The system of claim 18, wherein said voltage generator is operable to apply said voltage between −0 KV and −25 KV to said repelling electrode.

21. The system of claim 20, wherein said voltage generator is operable to generate said voltage such that the potential difference between said repelling electrode and said center electrode is between −35 KV and 0 KV.

22. The method of claim 20, wherein said voltage generator is operable to generate said voltage such that the potential difference between said repelling electrode and said peripheral electrode is between −10 KV and −25 KV.
